(19) United States
(12) Patent Application Publication
(10) Pub. No.: US 2004/0264175 A1
(43) Pub. Date: Dec. 30, 2004

(54) Fiber optic light with Fresnel condenser lens

(76) Inventor: Charles T. Willoughby, Saline, MI (US)

Correspondence Address: John G. Posa, Gifford, Krass, Groh, Sprinkle,, Anderson & Citkowski, P.C., 280 N. Old Woodward Ave., Suite 400, Birmingham, MI, 48009-5394, US

(21) Appl. No.: 10/603,753

(22) Filed: Jun. 25, 2003

(51) Int. Cl. F21V 21/084

(52) U.S. Cl. 362/105; 362/554; 362/570

(57) ABSTRACT

A head-mounted illuminator, particularly suited to surgical, medical and dental applications, includes a housing with a hollow interior having a light-receiving end and a light-projecting end. An optical fiber or fiber bundle is used to carry light from the source of light into the interior of the housing through the light-receiving end, and a Fresnel lens, mounted in the light-projecting end of the housing, receives light from the optical fiber and projects the light into a field of view. The Fresnel lens is constructed from acrylic material, enabling the design to focus and concentrate visible light. In the preferred “grooves in” embodiment, the light-projecting end and the light-receiving end of the housing are connected with a threaded coupling, enabling the light-projecting end to be moved forward and backward relative to the light-receiving end to adjust the light projected into the field of view. The light-projecting end of the housing is also preferably conical in shape, and terminates with a diameter larger than that of the light-receiving end. The head-mounted illuminator further includes a mechanism for mounting the housing to a wearer's head, preferably a mechanism for pivotally mounting.

### FIELD OF THE INVENTION

This invention relates generally to head-mounted illumination devices and, more particularly, to fiber-optic illuminator utilizing a Fresnel condenser lens.

### BACKGROUND OF THE INVENTION

Head-mounted illuminators for surgical, medical and dental applications, including fiber-optic-based devices, have been available for decades. U.S. Pat. No. 3,645,254 to Burton, for example, which issued in 1972, discloses a surgical light of the type adapted to be worn on the head of a user, including a harness element, a fiber-optic light carrier element, and a light projecting element in the form of a condensing lens. U.S. Pat. No. 3,745,993 also discloses a fiber-optic illuminator utilizing an acromat lens as a projection element. Another example is disclosed in U.S. Pat. No. 3,830,230.

Head-mounted fiber-optic-based illuminators utilizing Fresnel lenses as condensers are also known. Perhaps one of the earliest examples is described in U.S. Pat. No. 4,234,910, entitled “Head-Supported Illumination Device.” According to this reference, optical fibers are used to transfer light from a remote source to a pair of right and left projectors mounted on either side of a set of eyeglass frames. A further modification of an embodiment provides for a separate lens for collimating or focusing the light from each bundle, including a disclosure that “a Fresnel lens is ideally suited for this purpose.”

U.S. Pat. No. 5,430,622 to Li et al., resides in a compact surgical illumination system capable of dynamically adjusting the resulting field of illumination. In terms of the projection system, the patent states that “the particular type of lens or lenses used may include lens systems, lens arrays, grated index lenses and Fresnel lenses.”

Importantly, it will be noted that in each case of such disclosures employing Fresnel lenses, the descriptions mention the use thereof in passing, and are silent as whether the grooves or ridges of the Fresnel lens face inwardly or outwardly.

### SUMMARY OF THE INVENTION

This invention is directed to a head-mounted illuminator configured for use with a source of light, particularly suited to surgical, medical and dental applications. In terms of apparatus, the illuminator includes a housing with a hollow interior having a light-receiving end and a light-projecting end. An optical fiber is used to carry light from the source of light into the interior of the housing through the light receiving end, and a Fresnel lens, mounted in the light-projecting end of the housing, receives light from the optical fiber and projects the light into a field of view.

The Fresnel lens is constructed from acrylic material, enabling the design to better focus and concentrate visible light. The use of a “grooves-in” Fresnel lens in this configuration allows several advantages over existing configurations. For one, acrylic is lightweight, which allows for the use of a larger diameter lens which collects more light from the light source. Fresnel lenses also allow for very low f#, keeping the focal length and assembly short and small and enabling smaller diameter spot size at the image plane. The design of the lens also corrects for spherical aberrations to allow for more uniform illumination at the image plane and finally in the final configuration a smooth, cleanable outer surface is desired which is enabled by having the grooves facing inward and avoiding the use of another component to cover the grooves.

In the preferred embodiment, the light-projecting end and the light-receiving end of the housing are connected with a threaded coupling, enabling the light-projecting end to be moved forward and backward relative to the light-receiving end to adjust the beam elements projected into the field of view. The head-mounted illuminator further includes a mechanism for mounting the housing to a wearer's head, preferably a mechanism for pivotally mounting.

### BRIEF DESCRIPTION OF THE DRAWING

FIG. 1 shows the device of the present invention used to collect and condense light emitting from a fiber optic light guide.

### DETAILED DESCRIPTION OF THE INVENTION

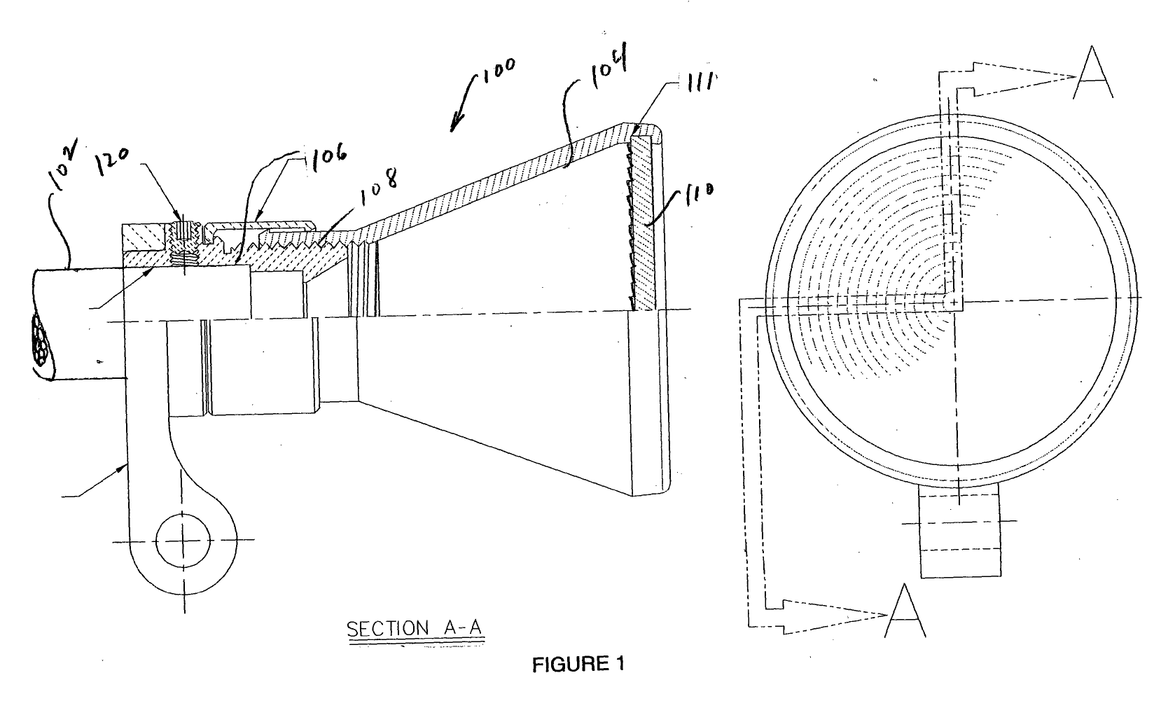

This invention is broadly directed to a device used to collect and condense light emitting from a light source, notably a fiber optic light guide. The basic concept is shown in FIG. 1. Here, a light guide 102 terminates in a housing 100 that serves to hold the light guide 102 and a Fresnel condenser lens 110. The housing 100 keeps the light guide 102 and lens 110 concentric and also functions to maintain a separation distance between the end of the light guide 102 and Fresnel lens 102. This separation distance is adjustable by means of rotating lens sub assembly 104 relative to the remaining housing 106 which, by use of threaded coupling 108, adjusts the position of the lens 110 relative to the end of the light guide 102. The light guide 102 is preferably held in place with a setscrew 120.

While the use of a lens to condense light from a light guide is not novel, but the use of a “grooves-in” (toward the guide 102) Fresnel lens in this configuration is new. The lens 110 had to be adapted from an existing design for use with infrared light manufactured by Fresnel Technologies Inc. of Ft. Worth, Tex. The original lens design was patented by Richard N. Claytor as described in U.S. Pat. No. RE 35,534, the entire content of which is incorporated herein by reference. According to this issued patent, a Fresnel lens was formed of an infrared transmitting material. According to this invention, this Fresnel lens was adapted by changing the material to acrylic, enabling the design to be compatible with visible light. The modified lens also had to be turned to proper diameter for the housing. Using this design, the grooves 111 can face the light source, also known as “grooves-in.” Other Fresnel lenses use the opposite design due to correct for optical aberrations. According to this invention, it was desirable to keep the grooves inside the mechanical assembly, leaving a smooth, cleanable surface on the outside.

The use of a “grooves-in” fresnel lens in this configuration allows several advantages over existing configurations; being made of Acrylic the lens is lightweight which allows for the use of a larger diameter lens which collects more light from the light source. Fresnel lenses also allow for very low f#, keeping the focal length and assembly short and small and enabling smaller diameter spot size at the image plane. The design of the lens also corrects for spherical aberrations to allow for more uniform illumination at the image plane and finally in the final configuration a smooth, cleanable outer surface is desired which is enabled by having the grooves facing inward and avoiding the use of another component to cover the grooves.

The configuration is ideally suited for use is in medical and dental applications, to illuminate the area of interest on a patient. For example, a surgeon or dentist would have this light attached to his head, allowing for coaxial illumination with the user's eyes that tracks head movements, always providing an illuminated field where the user is looking. The invention also finds utility in many other areas. Such applications could be industrial in nature, such a machine vision application, or could be productized for use in automotive application such as a reading light. The housing may be attached to the head in any manner, including clip-on structures, eyeglass-mounting, headband-mounting, and any other techniques disclosed in U.S. Pat. Nos. 5,440,462; 6,039,461; and 6,493,136, all of which are incorporated herein by reference.

I claim:

1. A head-mounted illuminator configured for use with a source of light, comprising:
a housing with a hollow interior having a light-receiving end and a light-projecting end;
an optical fiber carrying light from the source of light into the interior of the housing through the light receiving end;
a Fresnel lens mounted in the light-projecting end of the housing for receiving light from the optical fiber and projecting the light into a field of view, the Fresnel lens having a two sides, one with a sets of grooves; and
wherein the grooves of the Fresnel lens face the interior of the housing.

2. The head-mounted illuminator of claim 1, wherein the light-projecting end of the housing may be moved forward and backward relative to the light-receiving end to adjust the beam diameter of the light projected into the field of view.

3. The head-mounted illuminator of claim 1, wherein the light-projecting end and the light-receiving end of the housing are connected with a threaded coupling, enabling the light-projecting end to be moved forward and backward relative to the light-receiving end to adjust the beam diameter of the light projected into the field of view.

4. The head-mounted illuminator of claim 1, wherein the Fresnel lens is made of acrylic.

5. The head-mounted illuminator of claim 1, wherein the light-projecting end of the housing is conical in shape, and terminates with a diameter larger than that of the light-receiving end.

6. The head-mounted illuminator of claim 1, further including a mechanism for mounting the housing to a wearer's head.

7. The head-mounted illuminator of claim 1, further including a mechanism for pivotally mounting the housing to a wearer's head.
